(19) United States
(12) Patent Application Publication
(10) Pub. No.: US 2018/0340499 A1
(43) Pub. Date: Nov. 29, 2018

(54) INTAKE PASSAGE COMPONENT FOR INTERNAL COMBUSTION ENGINE

(71) Applicant: TOYOTA BOSHOKU KABUSHIKI KAISHA, Aichi (JP)

(72) Inventor: Yoshinori INUZUKA, Nishio-shi (JP)

(73) Assignee: TOYOTA BOSHOKU KABUSHIKI KAISHA, Aichi (JP)

(21) Appl. No.: 15/977,681

(22) Filed: May 11, 2018

(30) Foreign Application Priority Data
May 24, 2017 (JP) 2017-102533

(51) Int. Cl. F02M 35/14; B32B 5/02; F02B 77/13; F02M 35/02

(52) U.S. Cl. CPC F02M 35/14; B32B 5/022; B32B 2307/7242; F02M 35/0201; B32B 2262/0284; F02B 77/13

(57) ABSTRACT

A first housing of an air cleaner of an internal combustion engine includes a sound reducing wall portion, which includes an air-permeable sound absorbing layer made of nonwoven fabric and an air-impermeable foam layer, which is made of closed-cell plastic foam and is fixed to the outer surface of the sound absorbing layer.

### BACKGROUND

The present invention relates to an intake passage component for an internal combustion engine.

This type of intake passage component includes, for example, an air cleaner for an internal combustion engine.

The air cleaner disclosed in Japanese Laid-Open Patent Publication No. 2000-110682 includes a housing made of hard plastic and sound absorbing material. The sound absorbing material is composed of, for example, nonwoven fabric, glass wool, rock wool, or plastic foam and is attached to the inner surface of the wall portion of the air cleaner housing.

The wall portion of the housing of the air cleaner disclosed in Japanese Laid-Open Patent Publication No. 2002-21660 is formed by porous sound absorbing material such as filter paper, nonwoven fabric, an open-cell sponge.

In the air cleaner disclosed in Japanese Laid-Open Patent Publication No. 2000-110682, the intake noise is reduced by being absorbed by the sound absorbing material. However, in addition to being made of hard plastic, the housing includes the sound absorbing material. This undesirably increases the weight of the housing.

In the air cleaner disclosed in Japanese Laid-Open Patent Publication No. 2002-21660, since the wall portion of the air cleaner is formed by porous sound absorbing material, the weight of the housing can be reduced. However, there is a limit to the reduction in the transmission noise leaked to the outside of the housing through the wall portion solely by the relatively small transmission loss of the porous material. Transmission noise thus cannot be sufficiently reduced.

### SUMMARY

Accordingly, it is an objective of the present invention to provide an air cleaner for an internal combustion engine that reduces both the intake noise and the weight.

To achieve the foregoing objective, an intake passage component for an internal combustion engine is provided. The intake passage component constitutes a wall of an intake passage of an internal combustion engine and includes a sound reducing wall portion. The sound reducing wall portion includes an air-permeable sound absorbing layer, which is made of a porous material, and an air-impermeable foam layer, which is made of a closed-cell plastic foam and fixed to an outer surface of the sound absorbing layer.

### BRIEF DESCRIPTION OF THE DRAWINGS

FIG. 1 is a perspective view of an intake passage component for an internal combustion engine according to one embodiment, illustrating the overall structure of an air cleaner.

FIG. 2 is a cross-sectional view taken along line 2-2 of FIG. 1.

FIG. 3 is a cross-sectional view taken along line 3-3 of FIG. 2.

FIG. 4 is a schematic diagram showing the lamination structure of the noise reduction wall portion of the first housing in the same embodiment.

FIG. 5 is a schematic diagram showing the lamination structure of the noise reduction wall portion of a first housing in a modification.

### DETAILED DESCRIPTION OF THE PREFERRED EMBODIMENTS

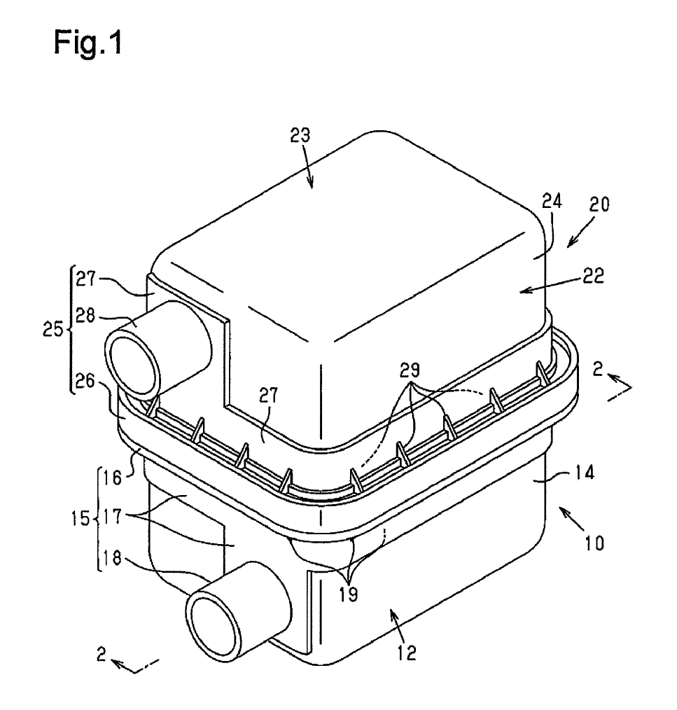

One embodiment will now be described with reference to FIGS. 1 to 4.

An air cleaner shown in FIGS. 1 to 3 is arranged in the intake passage of a vehicle-mounted internal combustion engine and includes a first housing 10 having an inlet 18 and a second housing 20 having an outlet 28.

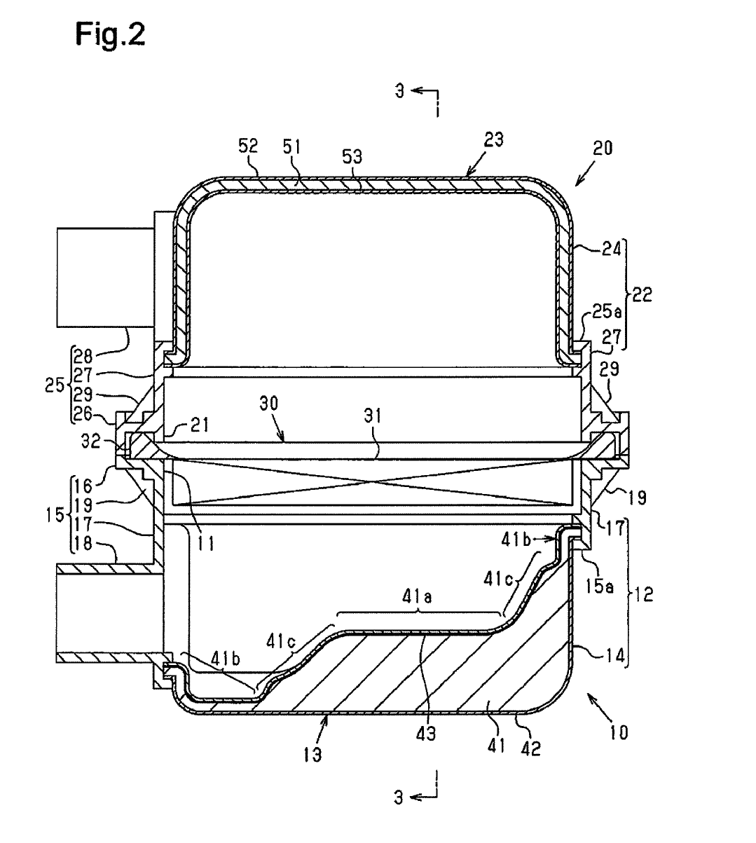

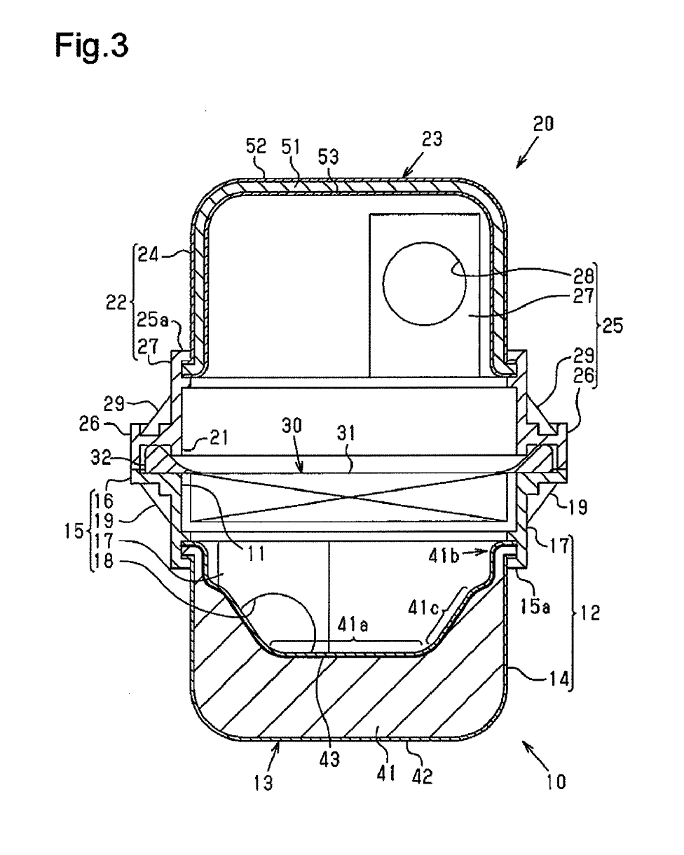

As shown in FIGS. 2 and 3, the first housing 10 includes a peripheral wall 12, which surrounds an upper opening 11, and a bottom wall 13. An outward extending flange 16 is provided around the entire periphery of the upper opening 11. The inlet 18 protrudes from the outer surface of the peripheral wall 12.

The second housing 20 includes a peripheral wall 22, which surrounds a lower opening 21, and a top wall 23. An outward extending flange 26 is provided around the entire periphery of the lower opening 21. The outlet 28 protrudes from the outer surface of the peripheral wall 22.

A filter element 30, which filters intake air, is arranged between the upper opening 11 of the first housing 10 and the lower opening 21 of the second housing 20. The filter element 30 has a filtration portion 31 and a loop-shaped sealing portion 32. The filtration portion 31 is formed by pleating a filtering medium sheet of, for example, filter paper or nonwoven fabric. The sealing portion 32 is made of closed-cell plastic foam such as polyurethane and provided at the outer periphery of the filtration portion 31.

The sealing portion 32 is held by the flange 16 of the first housing 10 and the flange 26 of the second housing 20. This seals the gap between the first housing 10 and the second housing 20.

The structure of the first housing 10 will now be described.

As shown in FIGS. 1 to 3, the first housing 10 has a molded plastic portion 15, which is made of hard plastic, and a sound reducing wall portion 14, which is made of, for example, nonwoven fabric.

The molded plastic portion 15 is a component that constitutes the flange 16, the inlet 18, and part of the peripheral wall 12. The molded plastic portion 15 is constituted by a plastic wall portion 17, which is located between the flange 16 and the inlet 18, and ribs 19, which protrude from the outer surface of the plastic wall portion 17 and the outer surface of the flange 16. The ribs 19 are arranged at intervals in the peripheral direction.

The sound reducing wall portion 14 is constituted by the bottom wall 13 and the peripheral wall 12 except the molded plastic portion 15.

The molded plastic portion 15 is integrally formed with the sound reducing wall portion 14 by insert molding.

The cross-sectional structure of the sound reducing wall portion 14 will now be described.

As shown in FIGS. 2 and 3, the sound reducing wall portion 14 includes an air-permeable sound absorbing layer 41 made of nonwoven fabric, an air-impermeable foam layer 42 made of closed-cell plastic foam, and an inner layer 43 made of air-permeable material. The foam layer 42 is fixed to the outer surface of the sound absorbing layer 41 with adhesive. The inner layer 43 is fixed to the inner surface of the sound absorbing layer 41 with adhesive. The inner layer 43 has a lower air permeability than the sound absorbing layer 41.

<Sound Absorbing Layer 41>

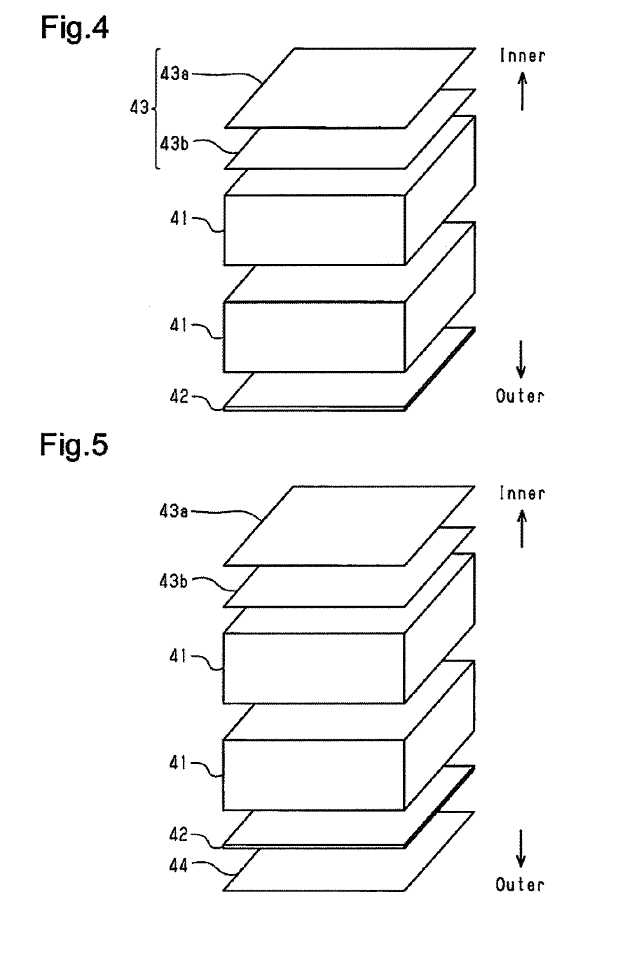

As shown in FIG. 4, the sound absorbing layer 41 is formed by laminating two sheets of nonwoven fabric. The nonwoven fabric sheets are each composed of known sheath-core bicomponent fibers including cores made of, for example, polyethylene terephthalate (PET) and sheaths made of a modified PET having a melting point lower than that of the PET of the cores (neither is illustrated).

The weight per unit area of the laminated nonwoven fabric sheets is preferably 300 to 1,500 g/m².

In the present embodiment, the weight per unit area of one nonwoven fabric sheet is 600 g/m², and the weight per unit area of two nonwoven fabric sheets (total value) is set to 1,200 g/m².

The sound absorbing layer 41, which is shown in FIGS. 2 and 3, is formed by hot pressing two laminated nonwoven fabric sheets having a total thickness of, for example, 30 mm to 100 mm. The sound absorbing layer 41 has a thick portion 41a, a thin portion 41b, and a gradual change portion 41c. The thin portion 41b has a higher degree of compression than the thick portion 41a and is thinner than the thick portion 41a. The gradual change portion 41c is located between the thick portion 41a and the thin portion 41b, and the thickness is gradually reduced from the thick portion 41a toward the thin portion 41b.

As shown in FIG. 2, the thick portion 41a is provided in a range on the bottom wall 13 of the first housing 10 that is farther from the inlet 18 with respect to the center (on the right side in FIG. 2). The thickness of the thick portion 41a is preferably 5 to 50 mm.

The thin portion 41b is provided over the entire periphery of the sound reducing wall portion 14. The periphery of the sound reducing wall portion 14 is held by a holding portion 15a of the molded plastic portion 15 from the opposite sides in the thickness direction. This integrates the sound reducing wall portion 14 and the molded plastic portion 15. The thickness of the thin portion 41b is preferably 1 to 3 mm.

<Foam Layer 42>

The foam layer 42 is composed of closed-cell plastic foam made of, for example, PET.

The weight per unit area of the foam layer 42 is preferably 30 to 500 g/m².

In the present embodiment, the weight per unit area of the foam layer 42 is set to 100 g/m².

The thickness of the foam layer 42 is preferably 1.0 to 10 mm.

<Inner Layer 43>

The inner layer 43 includes an air-permeable inner covering layer 43a made of nonwoven fabric and an air-permeable sheet 43b, which is arranged between the inner covering layer 43a and the sound absorbing layer 41 and has an air permeability lower than that of the inner covering layer 43a.

The nonwoven fabric constituting the inner covering layer 43a is composed of sheath-core bicomponent fibers including cores made of, for example, PET and sheaths made of a modified PET having a melting point lower than that of the PET of the cores.

The weight per unit area of the inner covering layer 43a is preferably 10 to 300 g/m².

In the present embodiment, the weight per unit area of the inner covering layer 43a is set to 50 g/m².

The sheet 43b is a film made of, for example, PP, and has a large number of vent holes (not shown).

The weight per unit area of the sheet 43b is preferably 10 to 300 g/m².

In the present embodiment, the weight per unit area of the sheet 43b is set to 100 g/m².

The air permeability of the sheet 43b and thus the air permeability of the inner layer 43 are controlled by the number and the sizes of the vent holes.

The air permeability of the inner layer 43 (measured in accordance with JIS L 1096, A-Method (Frazier Method)) is preferably 3 cm³/cm²·s or higher, and more preferably 5 cm³/cm²·s or higher. The air permeability of the inner layer 43 is preferably 50 cm³/cm²·s or lower, and more preferably 20 cm³/cm²·s or lower.

In the present embodiment, the air permeability of the inner layer 43 is set to 5 to 20 cm³/cm²·s.

The thickness of the inner layer 43 is preferably 1 to 500 μm. The thickness of the inner layer 43 of the present embodiment is, for example, 10 to 15 μm.

A base is formed by laminating a sheet of nonwoven fabric that is the material of the inner covering layer 43a, a film that is the material of the sheet 43b, two sheets of nonwoven fabric that are the material of the sound absorbing layer 41, and a sheet of closed-cell plastic foam that is the material of the foam layer 42. The base is heated in advance. Then, the heated base is cold pressed to form the above-described sound reducing wall portion 14 into a predetermined shape. Then, after performing the trimming process, injection molding is performed by inserting the sound reducing wall portion 14 into the molding die, thereby integrally molding the molded plastic portion 15 with the sound reducing wall portion 14.

The structure of the second housing 20 will now be described.

As shown in FIGS. 1 to 3, the second housing 20 has a molded plastic portion 25, which is made of hard plastic, and a compressed wall portion 24, which is made of, for example, nonwoven fabric.

The molded plastic portion 25 is a component that constitutes the flange 26, the outlet 28, and part of the peripheral wall 22. The molded plastic portion 25 is constituted by a plastic wall portion 27, which is located between the flange 26 and the outlet 28, and ribs 29, which protrude from the outer surface of the plastic wall portion 27 and the outer surface of the flange 26. The ribs 29 are arranged at intervals in the peripheral direction.

The compressed wall portion 24 is constituted by the top wall 23 and the peripheral wall 22 except the molded plastic portion 25.

The molded plastic portion 25 is integrally formed with the compressed wall portion 24 by insert molding.

The cross-sectional structure of the compressed wall portion 24 will now be described.

As shown in FIGS. 2 and 3, the compressed wall portion 24 includes a compressed layer 51, an outer layer 52, and an inner layer 53. The compressed layer 51 is made of nonwoven fabric. The outer layer 52 is fixed to the outer surface of the compressed layer 51 with adhesive. The inner layer 53 is fixed to the inner surface of the compressed layer 51 with adhesive.

The compressed layer 51 is made of the same nonwoven fabric as the sound absorbing layer 41 of the sound reducing wall portion 14. The compressed layer 51 is formed by hot pressing nonwoven fabric having a thickness of, for example, 30 to 100 mm. The thickness of the compressed layer 51 is preferably 1 to 3 mm.

The outer layer 52 is a waterproof film made of PP, for example.

The inner layer 53 is made of the same material as the inner layer 43 of the sound reducing wall portion 14.

The periphery of the compressed wall portion 24 is held by a holding portion 25a of the molded plastic portion 25 from the opposite sides in the thickness direction. This integrates the compressed wall portion 24 and the molded plastic portion 25.

An operation of the present embodiment will now be described.

When the intake noise enters the inner layer 43, the inner layer 43 is caused to resonate by the component of the noise that has the same frequency as the resonance frequency of the inner layer 43. The energy of the vibration vibrates the sound absorbing layer 41 fixed to the inner layer 43 and is consumed by being converted into the frictional heat of the sound absorbing layer 41.

The resonance frequency of the inner layer 43 is lowered as the mass of the air that is blocked by the inner layer 43 increases, that is, as the air permeability of the inner layer 43 decreases.

In the present embodiment, the inner layer 43 is made of an air-permeable material having a lower air permeability than that of the sound absorbing layer 41. Thus, intake noise of a low-frequency range is reduced as compared with a configuration in which the inner layer 43 is not provided or a configuration in which a layer having an air permeability greater than or equal to the air permeability of the sound absorbing layer is provided on the inner surface of the sound absorbing layer 41 (Operation 1).

In addition, the sound reducing wall portion 14 has the air-permeable sound absorbing layer 41 made of nonwoven fabric. Therefore, the intake noise is absorbed when passing through a portion of the sound absorbing layer 41, particularly through the thick portion 41a and the part of the gradual change portion 41c where the thickness is relatively great. That is, the sound absorbing layer 41 is vibrated by the intake noise, and the energy of the vibration is consumed by being converted into the frictional heat of the sound absorbing layer 41 (Operation 2).

The air-impermeable foam layer 42 made of closed-cell plastic foam is fixed to the outer surface of the sound absorbing layer 41. Therefore, when intake noise enters the foam layer 42 via the sound absorbing layer 41, the foam layer 42 is caused to resonate by the component of the noise that has the same frequency as the resonance frequency of the foam layer 42. The energy of the vibration vibrates the sound absorbing layer 41 fixed to the foam layer 42 and is consumed by being converted into the frictional heat of the sound absorbing layer 41.

The resonance frequency of the foam layer 42 is lowered as the mass of the air that is blocked by the foam layer 42 increases, that is, as the air permeability of the foam layer 42 decreases.

As described above, the foam layer 42 is air-impermeable. Thus, as compared with a configuration in which the foam layer 42 is not provided or a configuration in which a layer having an air permeability is provided on the outer surface of the sound absorbing layer 41, intake noise of a lower frequency range is reduced (Operation 3).

The foam layer 42 is made of closed-cell plastic foam. Therefore, a great number of air bubbles trapped inside the foam layer 42 absorb or reflect the intake noise, thereby reducing the transmission noise, which passes through the foam layer 42 (Operation 4).

The air cleaner for an internal combustion engine according to the present embodiment achieves the following operational advantages.

(1) The first housing 10 of the air cleaner of the internal combustion engine includes the sound reducing wall portion 14, which includes the air-permeable sound absorbing layer 41 made of nonwoven fabric and the air-impermeable foam layer 42, which is made of closed-cell plastic foam and is fixed to the outer surface of the sound absorbing layer 41.

Since this configuration achieves the operation 2, the generation of a standing wave of the intake noise inside the intake passage is limited, which reduces the intake noise from the entrance of the intake passage.

In addition, since the configuration achieves the above-described operations 3 and 4, the intake noise passing through the sound reducing wall portion 14 is effectively suppressed.

The sound reducing wall portion 14 has the sound absorbing layer 41 and the foam layer 42. Therefore, as compared with a conventional configuration in which a sound absorbing layer is fixed to the inner surface of a wall portion made of hard plastic, the weight of the first housing 10 is reduced.

The intake noise and the weight are thus both reduced.

(2) The inner layer 43, which is made of an air-permeable material and has a lower air permeability than the sound absorbing layer 41, is fixed to the inner surface of the sound absorbing layer 41.

This configuration achieves the above-described operation 1 and thus effectively reduces components of the low-frequency range of the intake noise. Further, it is possible to change the reducible frequency of the intake noise by changing the air permeability of the inner layer 43.

(3) The inner surface of the first housing 10 is formed by the inner layer 43 having an air permeability lower than that of the sound absorbing layer 41.

This increases the smoothness of the inner surface of the first housing 10 as compared with a configuration in which the inner layer 43 is not provided, that is, a configuration in which the sound absorbing layer 41 is exposed to the interior of the first housing 10. Therefore, air flows smoothly along the inner surface of the first housing 10, and the airflow resistance is reduced.

(4) The air permeability of the inner layer 43 is set to 5 to 20 cm³/cm²·s.

If the air permeability of the inner layer 43 is lower than 5 cm³/cm²·s, the resonance frequency of the inner layer 43 is further reduced. This is thought to reduce components of lower frequencies of the intake noise.

However, in this case, since the intake noise scarcely reaches the sound absorbing layer 41, the sound absorbing effect by the sound absorbing layer 41 is unlikely to be exerted. This has the drawback that high-frequency components (for example, components higher than 1 kHz) of the intake noise cannot be readily reduced.

In this respect, according to the above configuration, the air permeability of the inner layer 43 is in the range from 5 to 20 cm³/cm²·s. This prevents the drawback from being caused due to the air permeability of the inner layer 43 being set to be excessively low. Therefore, high-frequency components in the intake noise are reduced by the sound absorbing action of the sound absorbing layer 41. Further, low-frequency components (for example, components lower than 1 kHz) in the intake noise are reduced by using the resonance of the inner layer 43. Accordingly, components of a wider frequency range in the intake noise are reduced.

(5) The inner layer 43 includes the air-permeable inner covering layer 43a, which is made of nonwoven fabric, and the air-permeable sheet 43b, which is arranged between the inner covering layer 43a and the sound absorbing layer 41 and has an air permeability lower than that of the inner covering layer 43a.

This configuration allows the air permeability of the inner layer 43 to be easily changed by changing the number and the sizes of the vent holes of the sheet 43b.

(6) The inner layer 43 is fixed to the sound absorbing layer 41 with adhesive. Thus, the inner layer 43 is easily and firmly fixed to the sound absorbing layer 41. This adequately prevents the inner layer 43 from peeling off the sound absorbing layer 41 due to the intake pipe negative pressure generated during the operation of the internal combustion engine.

(7) The first housing 10 includes the molded plastic portion 15, which constitutes the flange 16, the inlet 18, and the plastic wall portion 17 located between the flange 16 and the inlet 18. The molded plastic portion 15 is integrated with the sound reducing wall portion 14.

The flange 16 is a portion against which the sealing portion 32 of the filter element 30 is pressed, and is thus required to have a high stiffness. In addition, the inlet 18 is a portion to which the inlet duct (not shown) is connected, and is thus required to have a high stiffness.

In this regard, although provided with the sound reducing wall portion 14, the above-described configuration adequately prevents the first housing 10 from having an insufficient stiffness.

(8) The sound absorbing layer 41 has the thick portion 41a and the thin portion 41b, of which the nonwoven fabric has a higher degree of compression than the thick portion 41a, and the thin portion 41b of the sound reducing wall portion 14 is coupled to the molded plastic portion 15.

This configuration increases the stiffness of the part of the sound reducing wall portion 14 that is coupled to the molded plastic portion 15 with the thin portion 41b, and allows the thick portion 41a to sufficiently exert the sound absorbing effect.

(9) The gradual change portion 41c is provided between the thick portion 41a and the thin portion 41b such that the thickness gradually decreases from the thick portion 41a to the thin portion 41b.

With this configuration, a step is unlikely to be formed at which the thickness of the sound absorbing layer 41 abruptly changes between the thick portion 41a and the thin portion 41b. This allows the intake air to flow smoothly inside the first housing 10 and reduces the airflow resistance.

(10) Only the first housing 10 has the sound reducing wall portion 14.

The thick portion 41a of the sound reducing wall portion 14 has a lower stiffness and a lower negative pressure resistance than the thin portion 41b. Since the first housing 10 is located on the upstream side of the filter element 30, the negative pressure acting on the first housing 10 is less than the negative pressure acting on the second housing 20.

In this respect, according to the above-described configuration, the sound reducing wall portion 14 is provided only in the first housing 10, but not in the second housing 20. Therefore, it is possible to ensure the negative pressure resistance of the first housing 10 and the second housing 20 and reduction of the intake noise by the sound reducing wall portion 14 at the same time.

(11) The air-impermeable foam layer 42 is provided on the outer surface of the sound absorbing layer 41. Also, the air-impermeable outer layer 52 is provided on the outer surface of the compressed layer 51. This prevents entry of water into the interior of the air cleaner.

(12) Part of the second housing 20 is formed by the compressed wall portion 24, which has the compressed layer 51 made of nonwoven fabric, the outer layer 52, and the inner layer 53.

With this configuration, as compared with a configuration in which the second housing 20 is made of hard plastic, it is easier to reduce the weight of the second housing 20 and further reduce the weight of the air cleaner

(13) The molded plastic portions 15, 25 are provided with the holding portions 15a, 25a for holding the periphery of the sound reducing wall portion 14 and the periphery the compressed wall portion 24, respectively.

With this configuration, when the molded plastic portions 15, 25 are insert-molded in the sound reducing wall portion 14 and the compressed wall portion 24, the molten plastic permeates into the periphery of the sound reducing wall portion 14 and the periphery of the compressed wall portion 24. This firmly joins the sound reducing wall portion 14 and the compressed wall portion 24 to the molded plastic portions 15, 25 by the anchor effect.

(14) A base is formed by laminating a sheet of nonwoven fabric that is the material of the inner covering layer 43a, a film that is the material of the sheet 43b, two sheets of nonwoven fabric that are the material of the sound absorbing layer 41, and a sheet of closed-cell plastic foam that is the material of the foam layer 42. The base is heated in advance. Then, the base is cold pressed to form the sound reducing wall portion 14 into a predetermined shape.

This manufacturing method reliably fixes the sound absorbing layer 41 and the foam layer 42 and reliably fixes the sound absorbing layer 41 and the inner layer 43 (the inner covering layer 43a and the sheet 43b). This ensures the above-described operation 3 of vibrating the sound absorbing layer 41 with the resonance of the foam layer 42 and also ensures the above-described operation 1 of vibrating the sound absorbing layer 41 with the resonance of the inner layer 43.

<Modifications>

The above-described embodiment may be modified as follows.

As shown in FIG. 5, an outer covering layer 44 made of an air-permeable material such as nonwoven fabric may be fixed to the outer surface of the foam layer 42. In this case, since the air-permeable outer covering layer 44 made of nonwoven fabric is provided on the outer surface of the foam layer 42, for example, noises from other sound sources in the engine compartment are absorbed by the outer covering layer 44. Therefore, in addition to the intake noise, other noises in the engine compartment are reduced.

The foam layer 42, which is made of plastic foam, is easily scratched. In this respect, the above-described configuration has the outer covering layer 44 made of nonwoven fabric, which covers the outer surface of the foam layer 42. This protects the foam layer 42. Also, since the outer covering layer 44 is made of nonwoven fabric, the outer covering layer 44 itself resists scratches.

The entire second housing 20 can be formed by the molded plastic portion 25.

A sound reducing wall portion similar to the sound reducing wall portion 14 of the first housing 10 can be provided in the second housing 20.

The gradual change portion 41c of the sound absorbing layer 41 can be omitted.

The entire first housing 10 can also be formed by the sound reducing wall portion 14. That is, the molded plastic portion 15 may be omitted. In this case, the portion corresponding to the molded plastic portion 15 only needs to be constituted by the thin portion 41b of the above-described embodiment.

The sound absorbing layer 41 may be constituted by a single sheet of nonwoven fabric or more than two laminated sheets of nonwoven fabric.

The sound absorbing layer 41 may be made of any air-permeable porous material. For example, the sound absorbing layer 41 can be made of open-cell plastic foam.

The inner layer 43 can be constituted solely by the inner covering layer 43a or the sheet 43b.

The inner layer 43 can be omitted. Even in this case, the above-described advantage (1) can be achieved.

For example, the present invention can be applied to an intake duct.

1. An intake passage component for an internal combustion engine, wherein the intake passage component constitutes a wall of an intake passage of an internal combustion engine and comprises a sound reducing wall portion, which includes
an air-permeable sound absorbing layer, which is made of a porous material, and
an air-impermeable foam layer, which is made of a closed-cell plastic foam and fixed to an outer surface of the sound absorbing layer.

2. The intake passage component for an internal combustion engine according to claim 1, wherein an inner layer is fixed to an inner surface of the sound absorbing layer, and the inner layer is made of an air-permeable material and has a lower air permeability than the sound absorbing layer.

3. The intake passage component for an internal combustion engine according to claim 2, wherein the inner layer includes
an inner covering layer, which is made of an air-permeable material, and
an air-permeable sheet, which is arranged between the inner covering layer and the sound absorbing layer and has a lower air permeability than the inner covering layer.

4. The intake passage component for an internal combustion engine according to claim 1, wherein an outer covering layer, which is made of an air-permeable material, is fixed to an outer surface of the foam layer.

5. The intake passage component for an internal combustion engine according to claim 1, wherein the intake passage component is a housing of an air cleaner.
